(19) United States
(12) Patent Application Publication
(10) Pub. No.: US 2014/0036522 A1
(43) Pub. Date: Feb. 6, 2014

(54) VEHICULAR LAMP

(71) Applicant: KOITO MANUFACTURING CO., LTD., Tokyo (JP)

(72) Inventor: Asami Nakada, Shizuoka (JP)

(73) Assignee: KOITO MANUFACTURING CO., LTD., Tokyo (JP)

(21) Appl. No.: 13/956,645

(22) Filed: Aug. 1, 2013

(30) Foreign Application Priority Data
Aug. 1, 2012 (JP) 2012-170846

(51) Int. Cl. F21S 8/10

(52) U.S. Cl. CPC F21S 48/00
USPC 362/511

(57) ABSTRACT

A vehicular lamp, has a light guide extending in a predetermined direction, and having an end surface located in the predetermined direction thereof, and a light source configured to cause light to be incident on the light guide from the end surface, and configured to emit the light incident from the end surface from a front surface portion of the light guide. Reflective elements that reflects the light incident on the light guide toward the front surface portion of the light guide are formed at a plurality of positions along the predetermined direction on a rear surface portion of the light guide. Each of the reflective elements is comprises a curved surface profile in a cross-section along a plane perpendicular to the predetermined direction.

### BACKGROUND

1. Technical Field

The present invention relates to vehicular lamps including a light guide.

2. Description of the Related Art

Conventionally, vehicular lamps are known which are configured to include a light guide placed so as to extend in a predetermined direction, and a light source placed so that light is incident on the light guide from its end surface located in the predetermined direction.

“Patent Document 1” describes a configuration of such a vehicle lamp in which a reflective element that reflects incident light on the light guide toward a front surface portion of the light guide is formed at a plurality of positions along the predetermined direction on a rear surface portion of the light guide.

The vehicular lamp disclosed in “Patent Document 1” is configured so that the light internally reflected by the plurality of reflective elements formed on the rear surface portion of the light guide is emitted from the front surface portion toward the front of the lamp.

Patent Document 1: Japanese Patent Application Laid-Open (Kokai) No. 2011-216279

### SUMMARY

In the light guide described in “Patent Document 1,” each reflective element is designed to have a linear surface profile in a cross section along a plane perpendicular to the predetermined direction, resulting in poor flexibility in controlling reflected light by the reflective elements.

One or more embodiments of the present invention provides a vehicular lamp including a light guide, which can increase flexibility in controlling reflected light by a plurality of reflective elements formed on a rear surface portion of the light guide.

One or more embodiments of the present invention includes a configuration of a light guide.

A vehicular lamp according to one or more embodiments of the present invention comprises a light guide placed so as to extend in a predetermined direction; and a light source placed so as to cause light to be incident on the light guide from an end surface located in the predetermined direction of the light guide, and configured to emit the light incident from the end surface from a front surface portion of the light guide, characterized in that a reflective element that reflects the light incident on the light guide toward the front surface portion of the light guide is formed at a plurality of positions along the predetermined direction on a rear surface portion of the light guide, and each of the reflective elements is designed to have a curved surface profile in a cross section along a plane perpendicular to the predetermined direction.

According to one or more embodiments of the present invention, the “predetermined direction” is not particularly limited to a specific direction as long as the light incident from the end surface located in the predetermined direction can be emitted from the front surface portion of the light guide.

According to one or more embodiments of the present invention, the cross-sectional shape of a general portion of the “light guide” (i.e., a portion other than the reflective elements) is not particularly limited to a specific cross-sectional shape as long as the light guide is placed so as to extend in the predetermined direction.

According to one or more embodiments of the present invention, each of the “reflective elements” may be formed so as to protrude from an outer peripheral surface of the general portion or to be recessed from the outer peripheral surface of the general portion. Although each of the “reflective elements” is designed to have a curved surface profile in the cross section along a plane perpendicular to the predetermined direction, curvature of the curve of the surface profile is not particularly limited to a specific value.

As shown in the above configuration, a vehicular lamp according to one or more embodiments of the present invention is configured so that the light of the light source, which is incident on the light guide placed to extend in the predetermined direction from the end surface located in the predetermined direction of the light guide, is reflected toward the front surface portion of the light guide by the plurality of reflective elements formed on the rear surface portion of the light guide. Since each reflective element is designed to have a curved surface profile in the cross section along a plane perpendicular to the predetermined direction, the following effects can be obtained.

According to one or more embodiments of the present invention, light reflected by each reflective element formed on the rear surface portion of the light guide is emitted forward from the front end surface. Since each reflective element is designed to have a curved surface profile in the cross section, the diffusion angle of internally reflected light from each reflective element in a direction perpendicular to the predetermined direction can be adjusted by setting the curvature of the curve of the surface profile to an appropriate value. Thus, the diffusion angle of emitted light from the front surface portion can also be adjusted.

As described above, according to one or more embodiments of the present invention, the vehicular lamp including the light guide can have increased flexibility in controlling reflected light by the plurality of reflective elements formed on the rear surface portion of the light guide.

According to one or more embodiments of the present invention, in the above configuration, if a general portion other than the reflective elements in the light guide is designed to have a circular surface profile in the cross section, and each of the reflective elements is designed to have a circular surface profile in the cross section, which is concentric with the circular surface profile in the cross section of the general portion, emitted light from the light guide can be handled as diverging light from the center position of the general portion in the cross section. Accordingly, the diffusion angle of the emitted light from the light guide can be easily adjusted by defining the range in which each reflective element is formed in the cross section by using a central angle from the center position of the general portion. Thus, the light diffusion angle in the direction perpendicular to the predetermined direction can be easily controlled.

According to one or more embodiments of the present invention, in the above configuration, if curvature of the curve of the surface profile in the cross section of each of the reflective elements is set to a value larger than curvature of the curve of the surface profile in the cross section of the general portion, a sufficiently large light diffusion angle in the direction perpendicular to the predetermined direction can be ensured.

According to one or more embodiments of the present invention, in the above configuration, if a lens member that controls transmission of the light emitted from the front surface portion of the light guide is placed on a front side of the light guide, the emitted light from the light guide can be accurately controlled. In this case, if the lens member is formed to have a greater width than the light guide in the cross section, the light emission area as a lamp can be increased.

According to one or more embodiments of the present invention, in the above configuration, if a light shielding member having a slit extending in the predetermined direction is placed on a front side of the light guide so as to cover both sides of the light guide in the cross section, the light guide can be made to appear lit with a narrow width through the slit. In this case, by adjusting as appropriate the curvature of the curve of the surface profile in the cross section of each reflective element, most of the light internally reflected by each reflective element can be radiated forward through the slit without being blocked by the light shielding member.

### BRIEF DESCRIPTION OF THE DRAWINGS

FIG. 1 is a plane cross-sectional view showing a vehicular lamp according to one or more embodiments of the present invention.

FIG. 2 is a sectional view taken along line II-II in FIG. 1.

FIG. 3 is a diagram similar to FIG. 2, showing a vehicular lamp according to one or more embodiments of the present invention.

FIG. 4 is a diagram similar to FIG. 2, showing a vehicular lamp according to one or more embodiments of the present invention.

FIG. 5 is a front view showing a main part of the vehicular lamp according to one or more embodiments of the present invention.

FIG. 6 is a diagram similar to FIG. 2, showing a vehicular lamp according to one or more embodiments of the present invention.

FIG. 7 is a plane cross-sectional view showing a vehicular lamp according to one or more embodiments of the present invention.

FIG. 8 is a plane cross-sectional view showing a vehicular lamp according to one or more embodiments of the present invention.

### DETAILED DESCRIPTION

Hereafter, embodiments of the present invention will be described with reference to accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

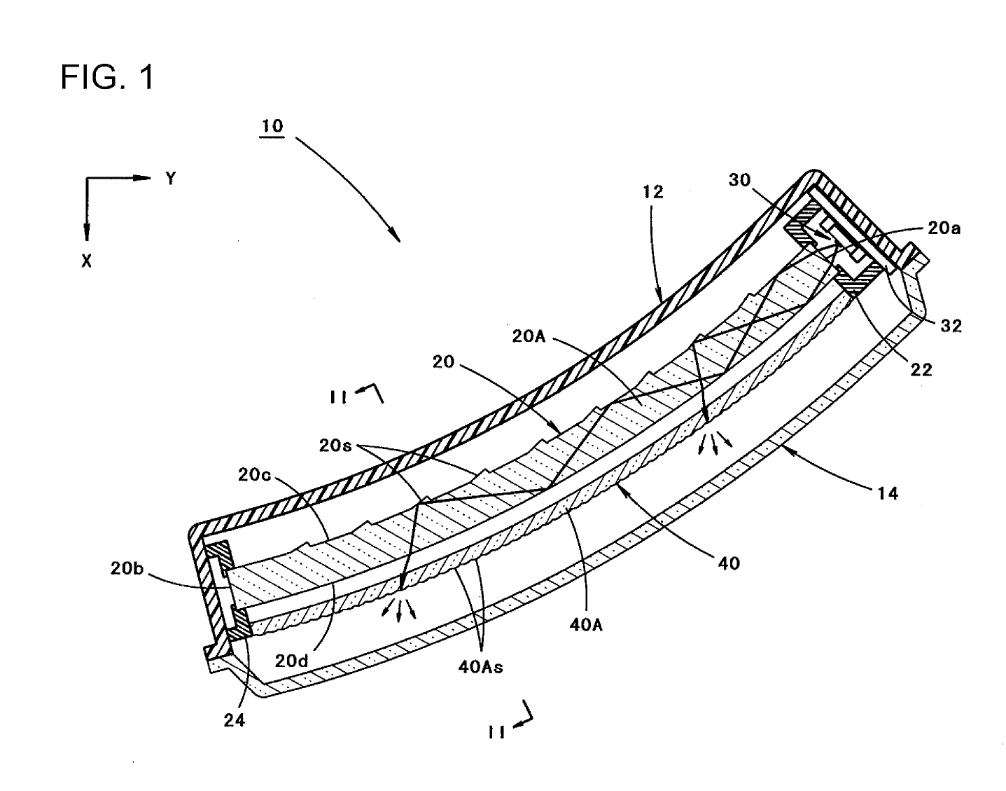

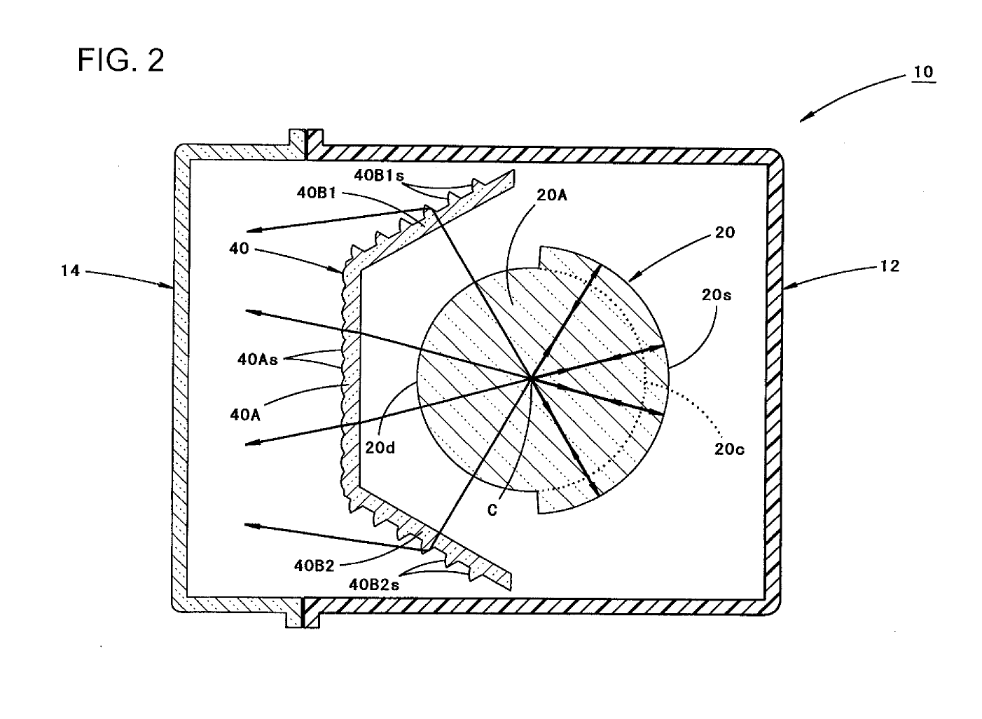

FIG. 1 is a plane cross-sectional view showing a vehicular lamp 10 according to one or more embodiments of the present invention. FIG. 2 is a sectional view taken along line II-II in FIG. 1.

As shown in these figures, the vehicular lamp 10 according to one more embodiments of the present invention is a tail lamp that is provided at the right rear end of a vehicle, and is configured so that a light guide 20 placed so as to extend in the lateral direction of the vehicle and a light source 30 placed so as to cause light to be incident on the light guide 20 from a right end surface 20a located outside in the lateral direction are incorporated in a lamp chamber formed by a lamp body 12 and a generally plain translucent cover 14 attached to an opening at the front end of the lamp body 12.

In the vehicular lamp 10, the direction shown by X in FIG. 1 is the “forward direction” (the “rearward direction” of the vehicle), and the direction shown by Y in FIG. 1 is the “rightward direction” perpendicular to the “forward direction.”

The light guide 20 is a transparent synthetic resin molded article made of an acrylic resin etc., and is formed as a light guiding bar extending in a curved shape so as to extend to the rear side from its left end surface 20b toward its right end surface 20a.

The light source 30 is a red light-emitting diode, and is placed in the vicinity of the right end surface 20a of the light guide 20 such that a light-emitting surface of the light source 30 faces the right end surface 20a. The light source 30 is supported by a light source support member 32. The light source support member 32 is supported by the lamp body 12.

The light guide 20 is supported at its right and left ends by light guide support members 22, 24, respectively. The light guide support member 22 supporting the right end of the light guide 20 is supported by the light source support member 32, and the light guide support member 24 supporting the left end of the light guide 20 is supported by the lamp body 12.

A reflective element 20s that reflects incident light on the light guide 20 toward a front surface portion 20d of the light guide 20 is formed on a rear surface portion 20c of the light guide 20 at a plurality of positions along a predetermined direction in which the light guide 20 extends. The plurality of reflective elements 20s are formed so as to protrude rearward with respect to a general portion (i.e., a portion other than the reflective elements 20s) 20A of the light guide 20. The reflective elements 20s are formed at regular intervals along the predetermined direction, have a wedge-shaped horizontal cross section, and are formed so as to extend in the vertical direction along the peripheral surface of the general portion 20A

As shown in FIG. 2, the general portion 20A is designed to have a circular surface profile in its vertical cross section along a plane perpendicular to the predetermined direction.

Each reflective element 20s is designed to have a circular surface profile in the vertical cross section, which is concentric with the circular surface profile in the vertical cross section of the general portion 20A. Each reflective element 20s is formed in an angular range close to 180° about the center position in the vertical cross section of the general portion 20A.

As shown in FIG. 1, in the light guide 20, incident light from the light source 30 onto the right end surface 20a is guided toward the left end surface 20b while being repeatedly totally internally reflected by the cylindrical peripheral surface of the general portion 20A, and part of the light reaches each reflective element 20s while the light is being guided toward the left end surface 20b. The light that has reached each reflective element 20s is totally internally reflected by the reflective element 20s, then reaches the front surface portion 20d at an incident angle of less than a critical angle, and is emitted from the front surface portion 20d in a direction toward the X axis.

At this time, since the general portion 20A has a cylindrical peripheral surface, light traveling toward each reflective element 20s while being guided by the general portion 20A can be handled as diverging light from the center position C in the vertical cross section, as shown in FIG. 2. Since each reflective element 20s is designed to have a circular surface profile in the vertical cross section, which is concentric with that of the general portion 20A, reflected light from each reflective element 20s is retroreflected light returning to the center position C. Thus, emitted light from the front surface portion 20d of the light guide 20 can also be handled as diverging light from the center position C.

A lens member 40 that controls transmission of light emitted from the front surface portion 20d of the light guide 20 is placed ahead of the light guide 20 in the lamp chamber.

The lens member 40 is a transparent synthetic resin molded article made of an acrylic resin etc., and is formed to have a greater width than the light guide 20 in the vertical cross section.

That is, the lens member 40 is formed by a vertical portion 40A located at the same height position as the light guide 20, having substantially the same vertical width as the light guide 20, and extending in the vertical direction, an upper tilted portion 40B1 extending obliquely upward from the upper end position of the vertical portion 40A toward the rear, and a lower tilted portion 40B2 extending obliquely downward from the lower end position of the vertical portion 40A toward the rear. The lens member 40 is formed so as to extend in the predetermined direction along the light guide 20.

A plurality of lens elements 40As that diffuse emitted light from the front surface portion 20d of the light guide 20 in the vertical and lateral directions are formed on the front surface of the vertical portion 40A. A plurality of lens elements 40B1s and 40B2s that totally internally reflect emitted light from the front surface portion 20d of the light guide 20 toward the front and then diffuse the light in the vertical and lateral directions are formed on the front surfaces of the upper tilted portion 40B1 and the lower tilted portion 40B2, respectively.

The lens member 40 is supported at its right and left ends by the light guide support members 22, 24.

The vehicular lamp 10 according to one or more embodiments of the present invention is configured so that light of the light source 30, which is incident on the light guide 20 placed to extend in the predetermined direction (the direction curved in the lateral direction of the vehicle) from the right end surface 20a located in the predetermined direction of the light guide 20, is reflected toward the front surface portion 20d of the light guide 20 by the plurality of reflective elements 20s formed on the rear surface portion 20c of the light guide 20. Since each reflective element 20s is designed to have a curved surface profile in a vertical cross section along a plane perpendicular to the predetermined direction, the following effects can be obtained.

Light reflected by each reflective element 20s formed on the rear surface portion 20c of the light guide 20 is emitted forward from the front end surface 20d. Since each reflective element 20s is designed to have a curved surface profile in the vertical cross section, the diffusion angle of internally reflected light from each reflective element 20s in a direction perpendicular to the predetermined direction (i.e., the vertical direction) can be adjusted by setting the curvature of the curve of the surface profile to an appropriate value. Thus, the diffusion angle of emitted light from the front surface portion 20d can also be adjusted.

As described above, according to one or more embodiments of the present invention, the vehicular lamp 10 including the light guide 20 can have increased flexibility in controlling reflected light by the plurality of reflective elements 20s formed on the rear surface portion 20c of the light guide 20.

In this case, in one or more embodiments of the present invention, the general portion 20A other than the reflective elements 20s in the light guide 20 is designed to have a circular surface profile in the vertical cross section, and each reflective element 20s is designed to have a circular surface profile in the vertical cross section, which is concentric with the circular surface profile in the vertical cross section of the general portion 20A. Emitted light from the light guide 20 can therefore be handled as diverging light from the center position C of the general portion 20A in the vertical cross section.

Accordingly, the diffusion angle of emitted light from the front surface portion 20d of the light guide 20 can be easily adjusted by defining the range in which each reflective element 20s is formed in the vertical cross section by using a central angle from the center position C of the general portion 20A. Thus, the light diffusion angle in the vertical direction can be easily controlled. In one or more embodiments of the present invention, since the range in which each reflective element 20s is formed is set to an angular range close to 180°, the maximum light diffusion angle in the vertical direction can be ensured.

In one or more embodiments of the present invention, since the lens member 40 that controls transmission of light emitted from the front surface portion 20d is placed ahead of the light guide 20, emitted light from the light guide 20 can be accurately controlled. Since the lens member 40 is formed to have a greater width than the light guide 20 in the vertical cross section, the light emission area as a lamp can be increased.

In particular, in the lens member 40, the upper tilted portion 40B1 and the lower tilted portion 40B2 are formed on the upper and lower sides of the vertical portion 40A located in front of the light guide 20, and the plurality of lens elements 40B1s and 40B2s that totally internally reflect emitted light from the front surface portion 20d of the light guide 20 toward the front and then diffuse the light in the vertical and lateral directions are formed on the front surfaces of the upper tilted portion 40B1 and the lower tilted portion 40B2, respectively. This allows the lens member 40 to appear lit in a wide range.

An example in which the light guide 20 is placed so as to extend in the horizontal direction is described above. However, in one or more embodiments of the present invention, the light guide 20 may be placed so as to extend in the vertical direction or an oblique direction.

An example in which a light-emitting diode is used as the light source 30 is described above. However, according to one or more embodiments of the present invention, light sources other than the light-emitting diode may be used.

An example in which the vehicular lamp 10 is a tail lamp provided at the right rear end of the vehicle is described above. However, according to one or more embodiments of the present invention, regardless of the position where the vehicular lamp is provided in the vehicle or the function of the vehicular lamp, effects similar to those of the above can be obtained by employing a similar configuration.

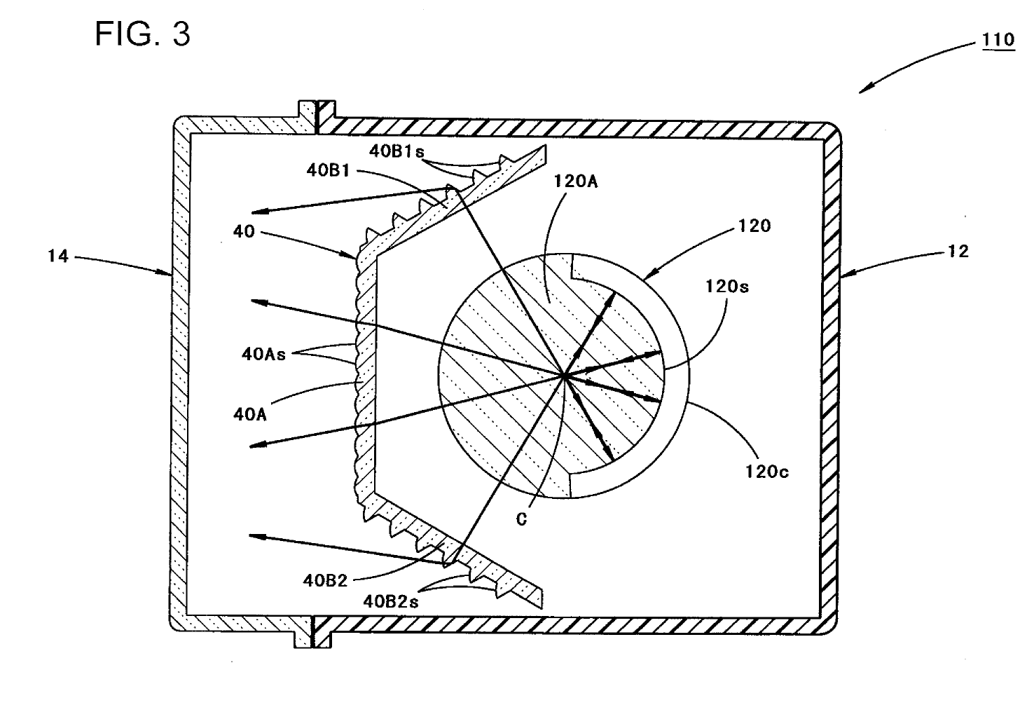

FIG. 3 is a diagram similar to FIG. 2, showing a vehicular lamp 110 according to one or more embodiments of the present invention.

As shown in the figure, in one or more embodiments of the present invention, the configuration of a light guide 120 is different from the light guide 20 described above.

That is, the light guide 120 of one or more embodiments of the present invention is also configured so that a plurality of reflective elements 120s are formed on a rear surface portion 120c of a general portion 120A having a configuration similar to that of the general portion 20A of the light guide 20 described above. However, each reflective element 120s is formed so as to be recessed forward with respect to the general portion 120A. In this case, the configuration is similar to the above in that each reflective element 120s is designed to have a circular surface profile in the vertical cross section, which is concentric with that of the general portion 120A, and that the range in which each reflective element 120s is formed is set to an angular range close to 180°.

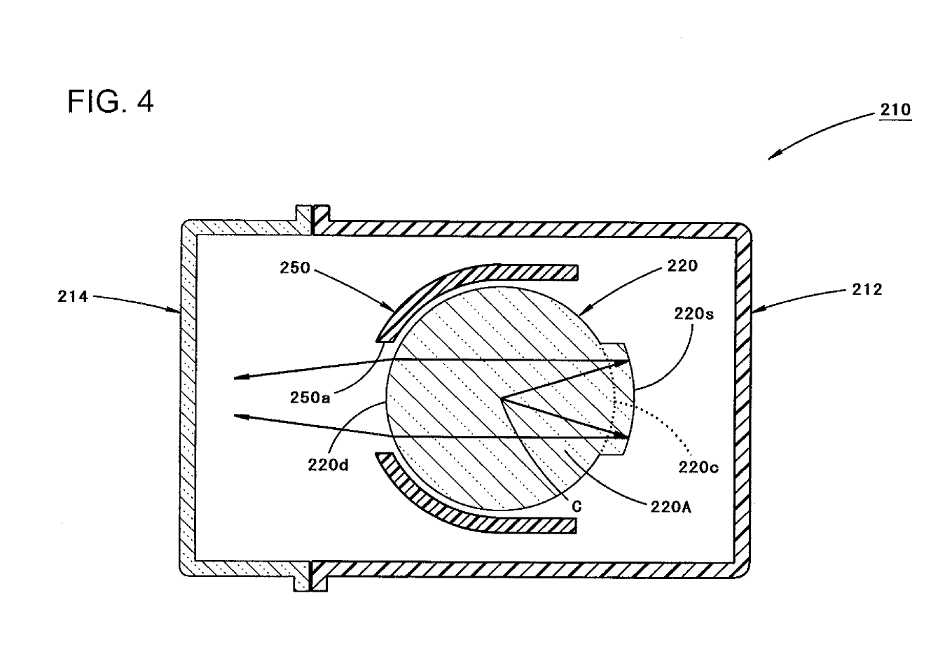

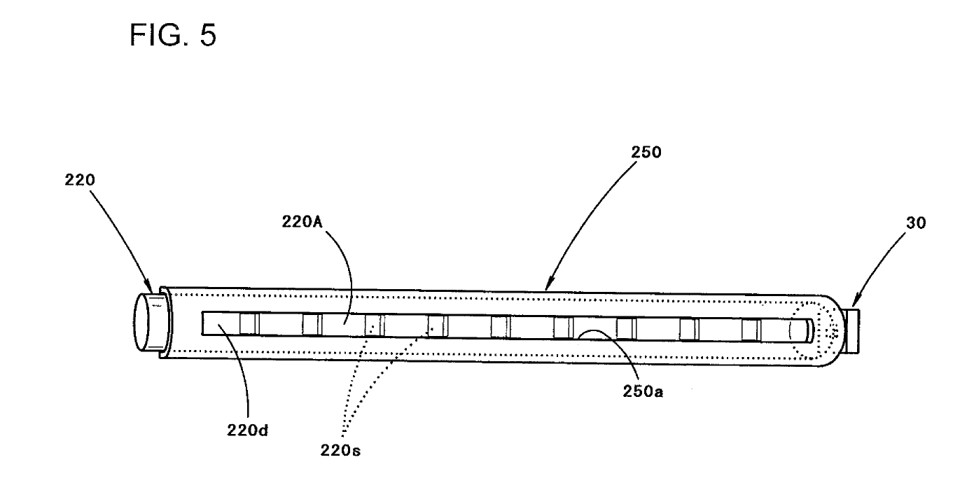

FIG. 4 is a diagram similar to FIG. 2, showing a vehicular lamp 210 according to one or more embodiments of the present invention. FIG. 5 is a front view showing a main part of the vehicular lamp 210.

As shown in these figures, in one or more embodiments of the present invention, the configuration of a light guide 220 is different from the light guide 220 described above. One or more embodiments of the present invention is configured so that a light shielding member 250 is placed ahead of the light guide 20 instead of the lens member 40 described above.

In one or more embodiments of the present invention, a lamp body 212 and a translucent cover 214 are formed so as to have a narrower vertical width than the lamp body 12 and the translucent cover 14 described above.

In one or more embodiments of the present invention, a plurality of reflective elements 220s are formed on a rear surface portion 220c of the light guide 220 so as to protrude rearward with respect to a general portion 220A. In this case, the general portion 220A has a configuration similar to that of the general portion 20A of the light guide 20 described above.

In one or more embodiments of the present invention, the range in which each reflective element 220s is formed is narrower than described above, and each reflective element 220s is formed so as to have a vertical width that is half or less than half the vertical width of the general portion 220A. Each reflective element 220s is formed so as to have a parabolic surface profile in the vertical cross section which has the center position C of the general portion 220A as its focal point. Thus, each reflective element 220s forms diverging light from the center position C into parallel light fluxes, and reflects them toward a front surface portion 220d of the light guide 220.

In the light guide 220, the parallel light fluxes from each reflective element 220s are emitted from the front surface portion 220d so as to converge in the vertical direction, so that the emitted light is light diffusing in the vertical direction.

The light shielding member 250 has a slit 250a extending in the predetermined direction along the light guide 220, and is placed so as to cover both upper and lower sides of the light guide 20. In this case, the slit 250a is formed so as to have a slightly greater vertical width than each reflective element 220s.

Employing this configuration allows the light guide 220 to appear lit with a narrow width through the slit 250a of the light shielding member 250.

In this case, each reflective element 220s of the light guide 220 is formed so as to have a vertical width slightly narrower than that of the slit 250a of the light shielding member 250, and light is reflected from each reflective element 220s as parallel light fluxes. Thus, light emitted from the front surface portion 220d of the light guide 220 can be radiated forward through the slit 250a without being blocked by the light shielding member 250. This can enhance lamp efficiency.

The light shielding member 250 may not be placed in this configuration. In this case as well, the light guide 220 is configured to emit from the front surface portion 220d the parallel light fluxes internally reflected by each reflective element 220s formed so as to have a narrow vertical width. This allows the light guide 220 to appear lit with a narrow vertical width.

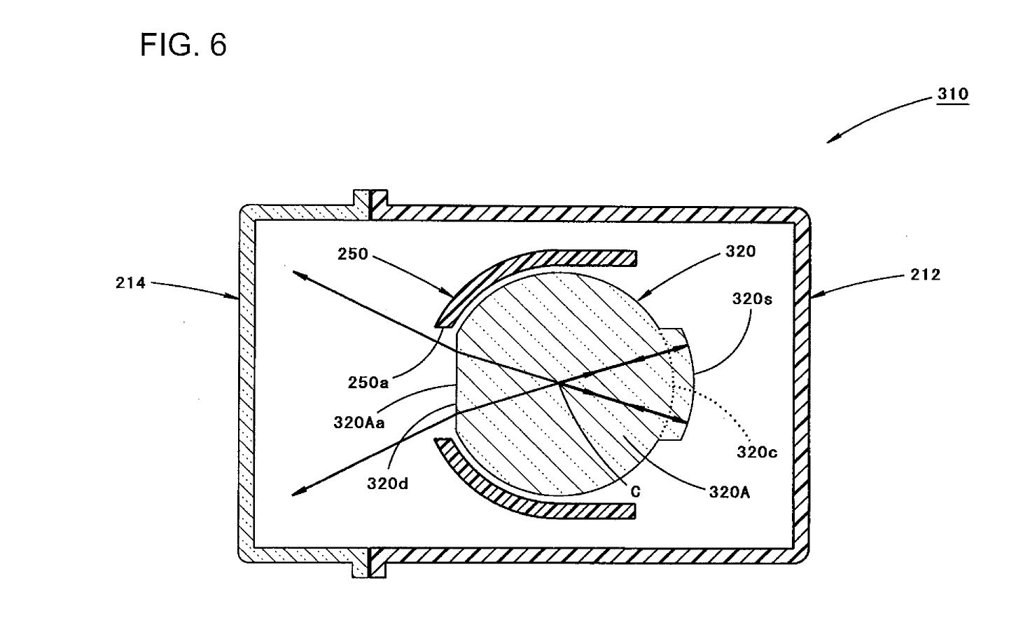

FIG. 6 is a diagram similar to FIG. 2, showing a vehicular lamp 310 according to one or more embodiments of the present invention.

As shown in the figure, the basic configuration is similar to that of FIGS. 4 and 5, but the configuration of a light guide 320 is different from that of the light guide 220.

In one or more embodiments of the present invention, a plurality of reflective elements 320s are formed on a rear surface portion 320c of the light guide 320 so as to protrude rearward with respect to a general portion 320A. In this case, the general portion 320A has a configuration similar to that of the general portion 220A of the light guide 220, and the range in which each reflective element 320s is formed is similar to that of each reflective element 220s.

In one or more embodiments of the present invention, however, each reflective element 320s is designed to have a circular surface profile in the vertical cross section, which is concentric with that of the general portion 320A. A vertical surface portion 320Aa, which is faulted by cutting off a part of the general portion 220A to form a vertical surface, is formed on a front surface portion 320d of the light guide 320. In this case, the vertical surface portion 320Aa is formed so as to be located at the same height position as each reflective element 320s and to have the same vertical width as each reflective element 320s.

In one or more embodiments of the present invention, reflected light from each reflective element 320s of the light guide 320 is retroreflected light traveling toward the center position C of the general portion 320A, as in the case described above. In this case, the retroreflected light reaches the vertical surface portion 320Aa of the general portion 320A, and is emitted from the vertical surface portion 320Aa as light diffusing in the vertical direction.

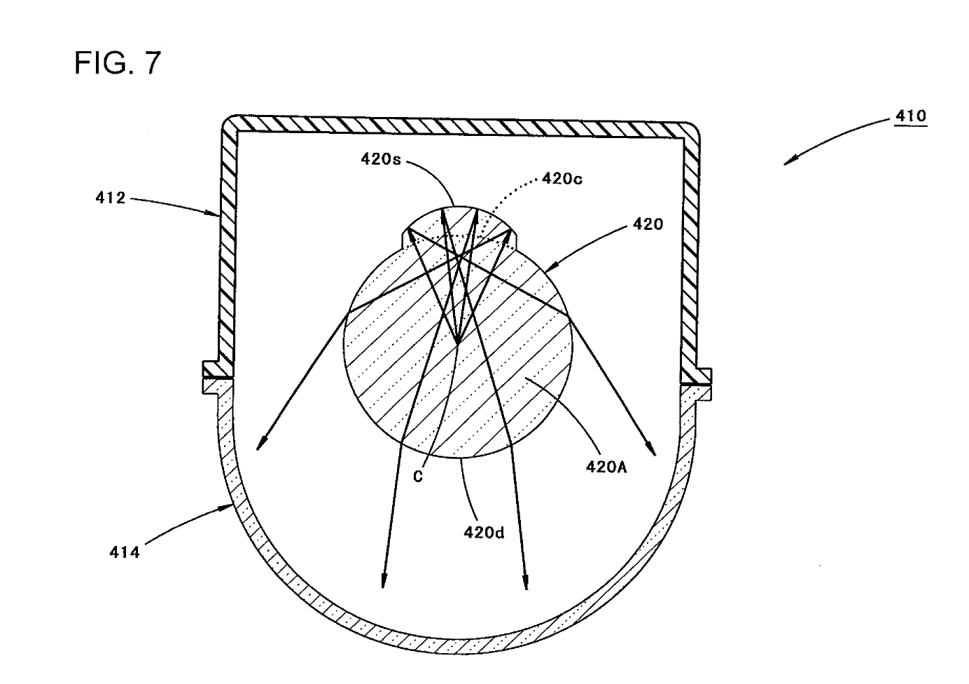

FIG. 7 is a plane cross-sectional view showing a vehicular lamp 410 according to one or more embodiments of the present invention.

As shown in the figure, in one or more embodiments of the present invention, the arrangement and configuration of a light guide 420 is different from those of the light guide 20 described above.

That is, the light guide 420 is placed so as to extend in the vertical direction. A plurality of reflective elements 420s are formed on a rear surface portion 420c of the light guide 420 so as to protrude rearward with respect to a general portion 420A. In this case, the reflective elements 420s are formed at regular intervals in the vertical direction as reflective elements having a wedge-shaped vertical cross section and extending in the horizontal direction.

In one or more embodiments of the present invention, a lamp body 412 and a translucent cover 414 are also formed so as to extend in the vertical direction.

In the light guide 420, the general portion 420A is designed to have a circular surface profile in a horizontal cross section, and each reflective element 420s is designed to have a circular surface profile in a horizontal cross section. The curvature of the curve of the surface profile of each reflective element 420s is set to a value larger than the curvature of the curve of the surface profile of the general portion 420A.

In the light guide 420 of one or more embodiments of the present invention, diverging light from the center position C of the general portion 420A reaches each reflective element 420s in the horizontal cross section. The light reflected by each reflective element 420s converges on the rear side of the center position C, and then reaches the front surface portion 420d of the light guide 420 as diffusing light. In this case, the reflected light from each reflective element 420s reaches the entire lateral width of the front surface portion 420d, and is emitted forward from the front surface portion 420d at a diffusion angle that is increased to a large extent to both right and left sides.

Employing this configuration can ensure a sufficiently large horizontal light diffusion angle in each reflective element 420s , and thus can ensure a sufficiently large lateral diffusion angle of light emitted from the light guide 420.

In a light guiding bar extending in the vertical direction, it is generally difficult to ensure a large lateral diffusion angle of emitted light. Accordingly, it is particularly effective to employ this configuration.

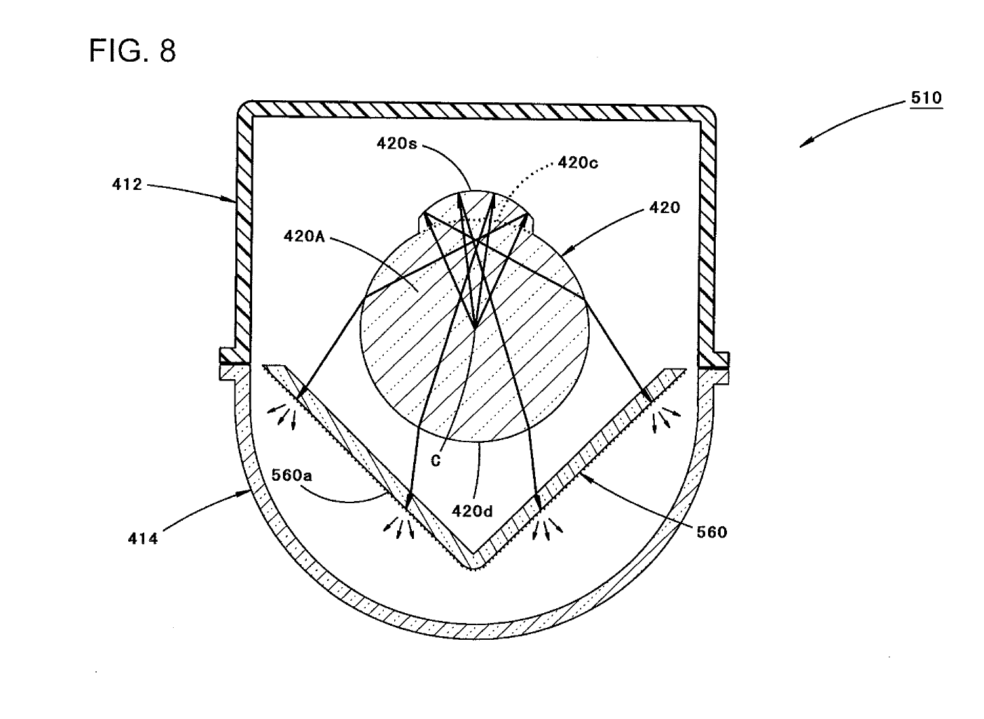

FIG. 8 is a plane cross-sectional view showing a vehicular lamp 510 according to one or more embodiments of the present invention.

As shown in the figure, the basic configuration is similar to that of FIG. 7, is different in that a lens member 560 is placed in front of the light guide 420.

The lens member 560 has an L-shaped cross section as viewed in plan. That is, the lens member 560 is formed so as to extend obliquely toward the right and left rear sides from a position located forward of the center position C of the general portion 420A of the light guide 420 to both right and left sides of the lens member 560.

The lens member 560 is formed to have a greater lateral width than the light guide 420 so that light emitted in a diffused manner from the light guide 420 is incident on the lens member 560 without loss. A front surface 560a of the lens member 560 has been subjected to a light scattering treatment by surface texturing etc.

In one or more embodiments of the present invention, light emitted in a diffused manner from the light guide 420 is incident on the lens member 560 placed ahead of the light guide 420, and is then emitted forward in a scattering manner from the front surface 560a of the lens member 560.

Employing this configuration allows the lens member 560 having a greater width than the light guide 420 to appear lit uniformly.

It should be understood that the numerical values shown as data in the above embodiments are by way of example only, and may be set to different values as appropriate.

The present invention is not limited to the configurations described above, and various other modified configurations can be employed. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF THE REFERENCE NUMERALS

10, 110, 210, 310, 410, 510 VEHICULAR LAMP

12, 212, 412 LAMP BODY

14, 214, 414 TRANSLUCENT COVER

20, 120, 220, 320, 420 LIGHT GUIDE

20A, 120A, 220A, 320A, 420A GENERAL PORTION

20a RIGHT END SURFACE

20b LEFT END SURFACE

20c, 120c, 220c, 320c, 420c REAR SURFACE PORTION

20d, 220d, 320d, 420d FRONT SURFACE PORTION

20s, 120s, 220s, 320s, 420s REFLECTIVE ELEMENT

22, 24 LIGHT GUIDE SUPPORT MEMBER

30 LIGHT SOURCE

32 LIGHT SOURCE SUPPORT MEMBER

40, 560 LENS MEMBER

40A VERTICAL PORTION

40B1 UPPER TILTED PORTION

40B2 LOWER TILTED PORTION

40As, 40B1s, 40B2s LENS ELEMENT

250 LIGHT SHIELDING MEMBER

250a SLIT

320Aa VERTICAL SURFACE PORTION

560a FRONT SURFACE

C CENTER POSITION

What is claimed is:

1. A vehicular lamp, comprising:
a light guide extending in a predetermined direction, and comprising an end surface located in the predetermined direction thereof; and
a light source configured to cause light to be incident on the light guide from the end surface, and configured to emit the light incident from the end surface from a front surface portion of the light guide,
wherein reflective elements that reflects the light incident on the light guide toward the front surface portion of the light guide are formed at a plurality of positions along the predetermined direction on a rear surface portion of the light guide, and
wherein each of the reflective elements is comprises a curved surface profile in a cross-section along a plane perpendicular to the predetermined direction.

2. The vehicular lamp according to claim 1,
wherein a general portion other than the reflective elements in the light guide is designed to have a circular surface profile in cross-section, and
wherein each of the reflective elements is designed to have a circular surface profile in cross-section, which is concentric with the circular surface profile in cross-section of the general portion.

3. The vehicular lamp according to claim 2, wherein curvature of the curve of the surface profile in cross-sections of each of the reflective elements is set to a value larger than curvature of the curve of the surface profile in cross-section of the general portion.

4. The vehicular lamp according to claim 1,
wherein a lens member that controls transmission of the light emitted from the front surface portion of the light guide is placed ahead of the light guide, and
the lens member is formed to have a greater width than the light guide in cross-section.

5. The vehicular lamp according to claim 1, wherein a light shielding member having a slit extending in the predetermined direction is placed ahead of the light guide so as to cover both sides of the light guide in cross-section.

6. The vehicular lamp according to claim 2,
wherein a lens member that controls transmission of the light emitted from the front surface portion of the light guide is placed ahead of the light guide, and
the lens member is formed to have a greater width than the light guide in cross-section.

7. The vehicular lamp according to claim 3,
wherein a lens member that controls transmission of the light emitted from the front surface portion of the light guide is placed ahead of the light guide, and
the lens member is formed to have a greater width than the light guide in cross-section.

8. The vehicular lamp according to claim 2, wherein a light shielding member having a slit extending in the predetermined direction is placed ahead of the light guide so as to cover both sides of the light guide in cross-section.

9. The vehicular lamp according to claim 3, wherein a light shielding member having a slit extending in the predetermined direction is placed ahead of the light guide so as to cover both sides of the light guide in cross-section.

10. The vehicular lamp according to claim 6, wherein a light shielding member having a slit extending in the predetermined direction is placed ahead of the light guide so as to cover both sides of the light guide in cross-section.

11. The vehicular lamp according to claim 7, wherein a light shielding member having a slit extending in the predetermined direction is placed ahead of the light guide so as to cover both sides of the light guide in cross-section.
